(19) United States
(12) Patent Application Publication
(10) Pub. No.: US 2026/0082319 A1
(43) Pub. Date: Mar. 19, 2026

(54) OPPORTUNISTICALLY STEERING A WIRELESS DEVICE TO ITS HOME NETWORK WHEN ROAMING

(71) Applicant: T-Mobile USA, Inc., Bellevue, WA (US)

(72) Inventor: Bhagwan Singh Khanka, Las Vegas, NV (US)

(21) Appl. No.: 18/886,882

(22) Filed: Sep. 16, 2024

(51) Int. Cl. H04W 48/18; H04W 64/00; H04W 76/27

(52) U.S. Cl. CPC H04W 48/18; H04W 64/00; H04W 76/27

(57) ABSTRACT

A wireless device retrieves its current location and determines its roaming status to be one of not roaming, domestic roaming, or international roaming. The wireless device determines whether its current location is within a buffer zone that is known to the wireless device. The buffer zone is a geographical area that is a difference between a first polygon defining a coverage footprint of a plurality of network nodes of the home network and a second polygon extending a first threshold distance outward from the coverage footprint of the plurality of network nodes of the home network. In response to determining that the roaming status of the wireless device is domestic roaming, and its current location is within the buffer zone, the wireless device takes at least one action related to a network search procedure of the wireless device.

### BACKGROUND

Roaming refers to the ability for a subscriber of a wireless telecommunications network to automatically make and receive voice calls, send and receive data, or access other services, including home data services, when traveling outside the geographical coverage area of the customer's home wireless telecommunications network (home network), by means of using a visited wireless telecommunications network (visitor or visited network). The term “home network” refers to the telecommunications network that the subscriber is registered to receive service from. The term “visited network” refers to the telecommunications network that the subscriber roams on temporarily and that is outside the bounds of the home network.

Generally, roaming functionality uses a location update mechanism to determine the location of the wireless device. When the wireless device is turned on or is transferred via a handover to the visited network, the visited network notices that the wireless device is not registered with the visited network, and attempts to identify a home network of the wireless device. If there is no roaming agreement between the two networks, maintenance of service is impossible, and service is denied by the visited network. If a roaming agreement exists, the visited network contacts the home network and requests service information (including whether or not the wireless device should be allowed to roam) about the wireless device using an international mobile subscriber identity (IMSI) number of the wireless device. If successful, the visited network begins to maintain a temporary subscriber record for the wireless device. Likewise, the home network updates its information to indicate that the wireless device is on the visited network so that any information sent to that wireless device can be correctly routed.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates fifth generation (5G) core network functions (NFs) that can implement aspects of the present technology.

FIG. 3 is a network diagram of a system in which at least some aspects of the disclosed technology are implemented.

FIG. 4 is a flowchart illustrating a method for implementing at least some aspects of the disclosed technology.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to a system for opportunistically steering a wireless device roaming on a visited network back to a home network of the wireless device, with the objective of improving the subscriber's network experience and/or reducing the amount of roaming fees chargeable to the subscriber. In some embodiments of the disclosed technology, a software component can be implemented on the wireless device. In some embodiments of the disclosed technology, a software component can be implemented on a remote server disposed in the home network. In some implementations, the software component can be a software application (“app”). In some implementations, the app can include a list of a plurality of cell sites in the home network. The list of the plurality of cell sites can include location coordinates or identifiers of the plurality of cell sites. In some implementations, the plurality of cell sites can be all cell sites in the home network. In some other implementations, the plurality of cell sites can be all cell sites within a local region around the wireless device. In some implementations, the app can further include a coverage map of the plurality of cell sites. The coverage map can indicate a coverage footprint of the home network, which is the geographical area in which the wireless device can receive service from the home network. In some implementations, a buffer zone extending a threshold distance beyond the outer edges of the home network's coverage footprint can be defined. The wireless device can be configured to determine whether it is connected to its home network or is roaming on a visited network using any procedure that is compatible with a third-generation partnership project (3GPP) standard. For example, the wireless device can be configured to compare a public land mobile network (PLMN) identifier of the network it is connected to with a PLMN identifier of its home network. If the PLMN identifiers match, the wireless device can determine that it is connected to its home network and is not roaming. If the PLMN identifiers do not match, the wireless device can determine that it is roaming on a visited network. When the wireless device, while roaming on the visited network, enters the buffer zone, the software component can take at least one of a plurality of actions to cause the wireless device to initiate a network search procedure. The plurality of actions can include causing the wireless device to search for the home network, enter an idle mode of operation, or sequentially enter and exit an airplane mode of operation of the wireless device.

In some embodiments, when the software component is implemented on a remote server in the home network, the wireless device can be configured to periodically report, using the visited network, a roaming indication and a current location of the wireless device to the remote server. The software component can be configured to determine, when the wireless device is roaming, whether the wireless device has entered the buffer zone based on the current location of the wireless device. When the software component determines that the wireless device is roaming and has entered the buffer zone, the software component can send at least one of a plurality of instructions to the wireless device to cause the wireless device to initiate a network search procedure. The plurality of instructions can include instructions to cause the wireless device to search for the home network, enter an idle mode of operation, or sequentially enter and exit an airplane mode of operation.

The inventor has recognized a need for new procedures beyond those specified by 3GPP standards to manage the timing and initiation of network search procedures of a wireless device when it is roaming on a visited network. The inventor has also recognized that opportunistically steering the wireless device to its home network can provide a better overall experience to the subscriber by improving network performance and/or reducing roaming fees that are chargeable to the subscriber. Accordingly, the inventor has developed the methods, systems, and/or devices disclosed herein for doing so.

The subscriber's home network operator may not provide service in certain geographical areas, and instead may have entered into a roaming agreement with a partner network service provider to provide roaming service to wireless devices of the home network's subscribers in those areas. In an ordinary mode of operation of the wireless device without the disclosed technology implemented, when the subscriber roams on the partner's network, known herein as the visited network, the home network loses control of the wireless device and hence can no longer control the subscriber's experience. On the other hand, the visited network may accord the subscriber's wireless device a lower priority than the visited network's own subscribers, potentially resulting in a second-class network experience for the subscriber when roaming on the visited network. Further, as per the roaming agreement between the two operators, the visited network may also have a financial incentive of earning higher roaming fees from the subscriber and/or the subscriber's home network operator by retaining the subscriber on the visited network for longer than may be necessary. The visited network may also have configured power, handover, or network search parameters differently than the home network. In one example, the visited network may have configured network search parameters according to 3GPP standards to conserve the wireless device's battery by gradually increasing the period between “tune away” events during which the wireless device tunes away from the visited network to search for a better network, such as the wireless device's home network. For example, immediately after entering a roaming state of operation and connecting to the visited network, the wireless device may tune away from the visited network once every few seconds to search for its home network. When the home network is not found, the wireless device may gradually reduce the frequency of tune away events, eventually searching for the home network once every few minutes, then once every few hours, and so on. Thus, for these as well as a variety of other reasons, including prudent network optimization and performance management approaches, network parameters of the visited network may be configured such that the wireless device, when roaming on the visited network, may be instructed by the visited network to not initiate a network search procedure to find its home network for long periods of time. As a result, in a scenario when the wireless device reenters its home network's coverage area after a previous unsuccessful home network search, it may be unaware that its home network has become available until it initiates the next network search, which could be several seconds, minutes, or hours later. Thus, even after returning to its home network's coverage area, the wireless device may miss out on opportunities to find and connect to the home network until after it is well within the home network's coverage area.

The disclosed technology addresses the aforementioned problems by defining a buffer zone that extends a threshold distance outside the home network's coverage footprint, and implementing a software component configured to, when the wireless device is roaming on a visited network, determine whether the wireless device has entered the buffer zone and, when it has, initiate at least one action to cause the wireless device to initiate a network search. In some embodiments, the software component is implemented on the wireless device. In some embodiments, the software component is implemented on a remote server, and the wireless device is configured to report a current location of the wireless device to the remote server.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

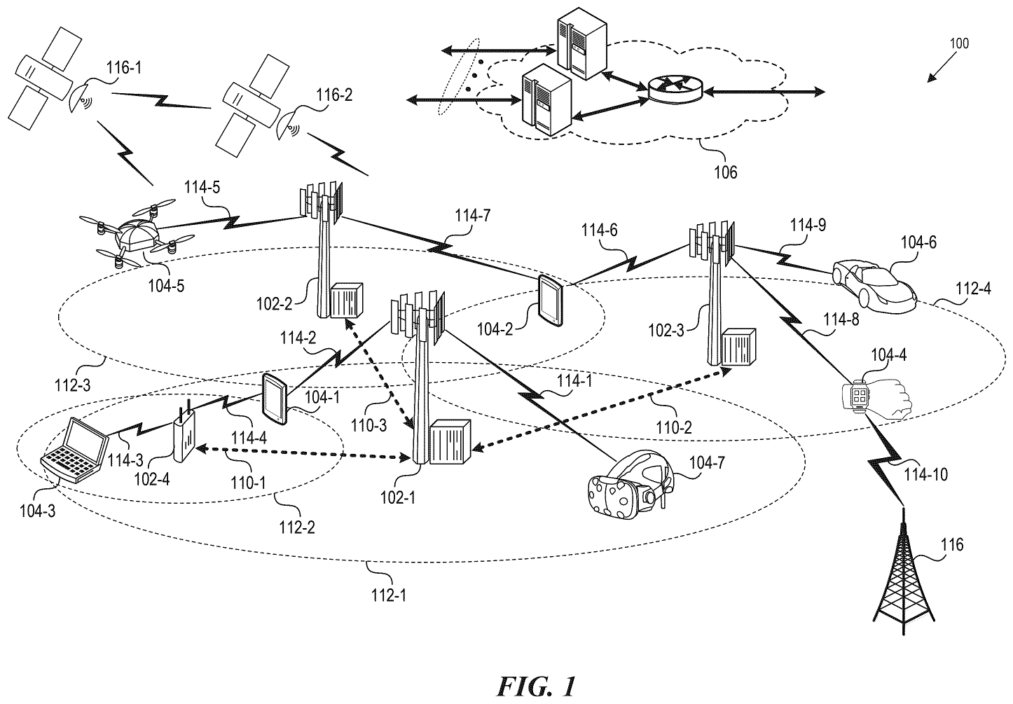

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. In some implementations, a 5G communication channel can use access frequencies of 24 GHz or more. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

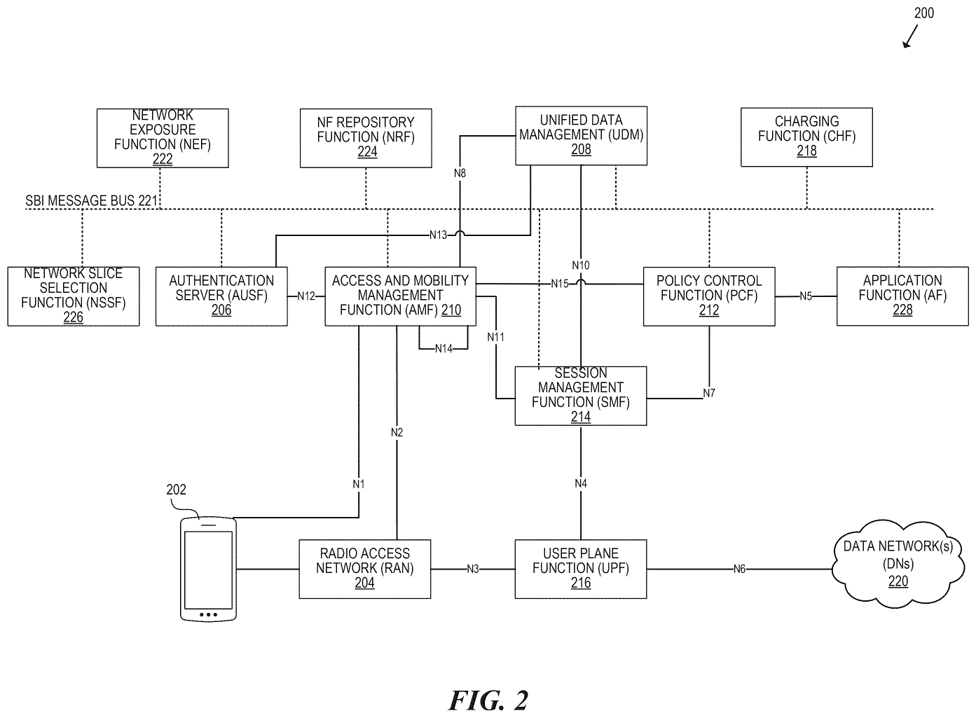

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator's infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Opportunistically Steering a Wireless Device to Its Home Network When Roaming

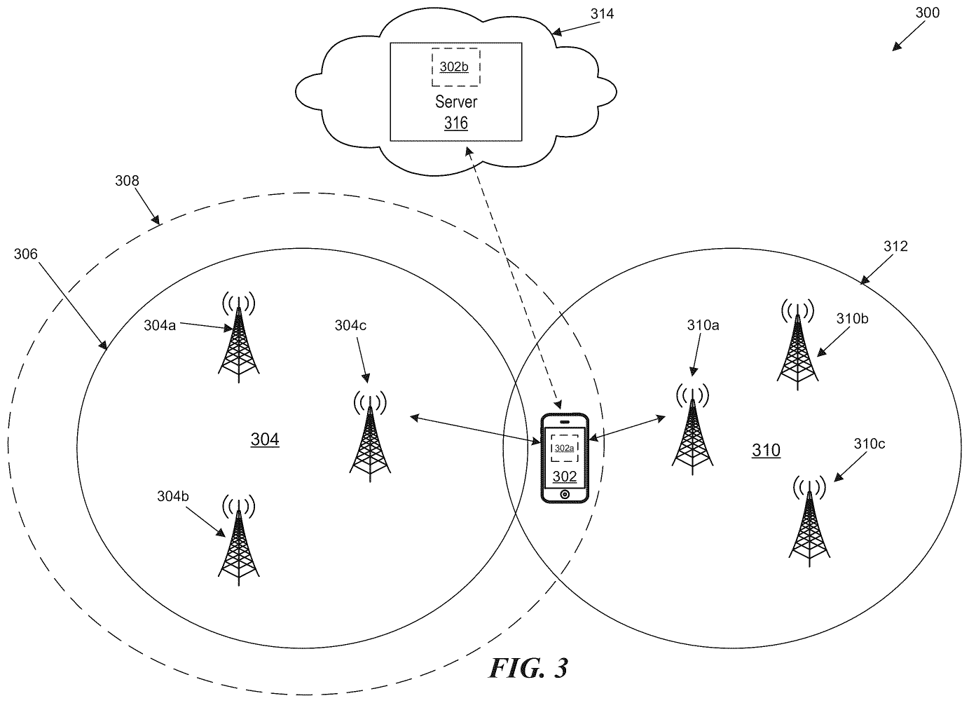

FIG. 3 is a network diagram of a system 300 in which at least some aspects of the disclosed technology are implemented. The disclosed technology relates to opportunistically steering a wireless device 302 that is roaming on a visited network 310 back to its home network 304. The home network 304 of the wireless device 302 can comprise a first core network (not shown) of the home network 304 and a plurality of Radio Access Network (RAN) nodes 304a, 304b, 304c, and so on. Conversely, the individual RAN nodes 304a, 304b, 304c, and so on can be collectively referred to as the home network 304 of the wireless device 302. The RAN nodes 304a, 304b, 304c, and so on can also be referred to herein as network nodes 304a, 304b, 304c, and so on. The home network 304 is operated by an operator of the home network 304 to provide wireless telecommunications service to its subscribers within a geographical area. The geographical area in which the home network provides service can be referred to as the coverage footprint 306 of the home network 304. The home network 304 can be identified by a globally unique public land mobile network (PLMN) identifier comprising a three-digit mobile country code (MCC) and a three-digit mobile network code (MNC). The visited network 310 can be a partner network of the home network 304 that is operated by another operator. The visited network 310 can be identified by a globally unique PLMN identifier comprising a three-digit MCC and a three-digit MNC. The visited network 310 can comprise a second core network (not shown) of the visited network 310 and a plurality of RAN nodes 310a, 310b, 310c, and so on. Conversely, the individual RAN nodes 310a, 310b, 310c, and so on can be collectively referred to as the visited network 310 of the wireless device 302. The RAN nodes 310a, 310b, 310c, and so on can also be referred to herein as network nodes 310a, 310b, 310c, and so on. Operators of the home network 304 and the visited network 310 may have signed a roaming agreement that allows the wireless device 302 to “roam” on the visited network 310, i.e., to receive service from the visited network 310 when the wireless device 302 is within a geographical area in which the visited network 310 provides service. The geographical area in which the visited network 310 provides service can be referred to as the coverage footprint 312 of the visited network 310. Thus, the wireless device 302 can be referred to herein as roaming on the visited network 310 when it receives service from the visited network 310 when the wireless device 302 is outside the coverage footprint 306 of the home network 304 but within the coverage footprint 312 of the visited network 310. In some implementations, when the wireless device 302 is roaming on the visited network 310, it can be connected to RAN nodes 310a, 310b, 310c, and so on of the visited network 310, with the visited network 310 routing traffic to and from the wireless device 302 via the first core network of the home network 304.

In some embodiments, the disclosed technology can include a software component 302a implemented on the wireless device 302. In some implementations, the software component 302a can be a software application or “app” implemented on the wireless device 302. In some embodiments, the software component 302a can be a firmware component implemented on the wireless device 302. In some implementations, the software component 302a can include a list of the plurality of network nodes 304a, 304b, 304c, and so on of the home network 304. The list of the plurality of network nodes 304a, 304b, 304c, and so on can further include location coordinates or identifiers of the plurality of network nodes 304a, 304b, 304c, and so on. In some implementations, the list of the plurality of network nodes 304a, 304b, 304c, and so on can include all network nodes of the home network 304. In some implementations, the software component 302a can further include a coverage map indicating the coverage footprint 306 of the plurality of network nodes 304a, 304b, 304c, and so on.

In some implementations, the list of the plurality of network nodes can include a subset of network nodes of the home network 304 that are within a first threshold distance around a current location of the wireless device 302, such as network nodes 304a, 304b, and 304c. As the wireless device 302 moves around, the plurality of network nodes that comprise the subset of network nodes of the home network 304 that are within the first threshold distance around a current location of the wireless device 302 can change. In some implementations, as the wireless device 302 moves around, it can periodically receive from the home network 304 an updated list of the plurality of network nodes that are within the first threshold distance around a current location of the wireless device 302. In some implementations, as the wireless device 302 moves around, it can periodically request the home network 304 to send, and subsequently receive from the home network 304, an updated list of the plurality of network nodes that are within the first threshold distance around a current location of the wireless device 302.

In some implementations, the list of the plurality of network nodes 304a, 304b, 304c, and so on can be periodically updated as a network topology of the home network 304 changes, such as when new network nodes are added to the home network 304, existing network nodes are decommissioned, a temporary service impairment is experienced, scheduled or unscheduled maintenance activity occurs, or a change in service levels or coverage areas is experienced due to engineering changes. In some implementations, the list of the plurality of network nodes 304a, 304b, 304c, and so on can be downloaded into the wireless device 302 during an initial configuration of the wireless device 302. In some implementations, the list of the plurality of network nodes 304a, 304b, 304c, and so on can be downloaded into the wireless device 302 each time the wireless device 302 is powered on and successfully establishes a connection with a network.

In some implementations, a buffer zone 308 can be defined. In some implementations, the buffer zone 308 can be defined by the operator of the home network 304 as extending a second threshold distance beyond the coverage footprint 306 of the home network 304. In some implementations, the buffer zone 308 can partially overlap the coverage footprint 306 of the home network 304. In some implementations, the buffer zone 308 can be defined by the operator of the home network 304 as extending a third threshold distance around the location of each of the plurality of network nodes 304a, 304b, 304c, and so on. The buffer zone 308 can be configured by the operator of the home network 304, and can be known to the home network 304, the wireless device 302, or both. In some implementations, the software component 302a can be configured to determine whether the wireless device 302 is roaming on the visited network 310. For example, in some implementations, the software component 302a can be configured to compare the PLMN identifier of the network to which the wireless device 302 is connected to the PLMN identifier of the home network 304. If the PLMN identifiers match, the wireless device 302 or the software component 302a can determine that the wireless device 302 is connected to its home network 304 and is not roaming. If the PLMN identifiers do not match, the wireless device 302 or the software component 302a can determine that the wireless device 302 is roaming on the visited network 310. The particular method used by the wireless device 302 or the software component 302a to determine whether the wireless device 302 is connected to its home network 304 or the visited network 310 should not be construed as limiting, and the software component 302a may obtain an indication about the wireless device 302's roaming status using any of the methods generally used in the art to determine whether the wireless device 302 has entered a roaming mode of operation.

In some implementations, when the wireless device 302 is roaming on the visited network 310, the software component 302a can be configured to periodically monitor the current location of the wireless device 302 to determine whether the wireless device 302 has entered the buffer zone 308. When the software component 302a, upon determining that the wireless device 302 is roaming on the visited network 310, further determines that the wireless device 302 has entered the buffer zone 308, the software component 302a can take at least one of a plurality of actions to cause the wireless device 302 to initiate a network search procedure. The plurality of actions can include causing the wireless device 302 to search for the home network 304, enter an idle mode of operation of the wireless device 302, or sequentially enter and exit an airplane mode of operation of the wireless device 302. In some implementations, when the wireless device 302 is caused by the software component 302a to search for the home network 304, the wireless device 302 can do so according to any of the 3GPP standards-compliant procedures that are generally known in the art. In some implementations, when the wireless device 302 is caused by the software component 302a to enter an idle mode of operation of the wireless device 302, the wireless device 302 can subsequently initiate a tune away event according to any of the 3GPP standards-compliant procedures that are generally known in the art to search for a preferred network that is assigned a higher priority for connection than the visited network 310 by the operator of the home network 304. In some implementations, when the wireless device 302 is caused by the software component 302a to sequentially enter and then exit an airplane mode of operation of the wireless device 302, the wireless device 302 may, upon exiting the airplane mode of operation, perform the network search procedure according to any of the 3GPP standards-compliant procedures that are generally known in the art. Subsequently, upon finding a signal from the home network 304, the wireless device 302 can, if it was connected to the visited network 310 immediately prior to conducting the network search procedure, disconnect from the visited network 310 and connect to the home network 304.

In some embodiments, the disclosed technology can include a software component 302b that is implemented on a server 316 disposed in a remote computing environment 314. The software component 302b can be referred to herein as a roaming management function (RMF). In some implementations, the remote computing environment 314 can be a component of the home network 304. In some implementations, the wireless device 302 can be configured to periodically report, using the visited network 310, a roaming indication and a current location of the wireless device 302 to the RMF 302b. The RMF 302b can be configured to determine, when the wireless device 302 is roaming, whether the wireless device 302 has entered the buffer zone 308 based on the current location of the wireless device 302. When the RMF 302b determines that the wireless device 302 is roaming and has entered the buffer zone 308, the RMF 302b can send at least one of a plurality of instructions to the wireless device 302 to cause the wireless device 302 to initiate a network search procedure. The plurality of instructions can include instructions to cause the wireless device 302 to search for the home network 304, enter an idle mode of operation of the wireless device 302, or sequentially enter and exit an airplane mode of operation of the wireless device 302.

In some implementations, when the wireless device 302 is in an area that is known to the software component 302a or the RMF 302b to be outside the coverage footprint 306 of the home network 304, the software component 302a or the RMF 302b can instruct the wireless device 302 to not initiate a network search procedure. In some implementations, the software component 302a can be configured to retrieve from an internal system of the wireless device 302 a current connection state of the wireless device 302. In some implementations, the current connection state of the wireless device 302 can be one of a plurality of connection states including idle state, inactive state, or connected state. In some implementations, when the wireless device 302 is compliant with a 3GPP long-term evolution (LTE) or fifth generation (5G) standard, the connection state of the wireless device 302 can be one of a plurality of connection states including Radio Resource Control (RRC) Idle (RRC_Idle) connection state, RRC Inactive (RRC_Inactive) connection state, or RRC Connected (RRC_Connected) connection state. In some implementations, the software component 302a can be configured to retrieve from an internal system of the wireless device 302 an active voice call indicator that indicates that the wireless device 302 is in an active voice call. In some implementations, when the active voice call indicator indicates that the wireless device 302 is in an active voice call, the software component 302a can be configured to delay taking the at least one of a plurality of actions until after the wireless device 302 is no longer in the active voice call. In some implementations, when the active voice call indicator indicates that the wireless device 302 is in an active voice call, the software component 302a can be configured to cause a message to be displayed on a screen of the wireless device 302. In some implementations, the message can indicate to the subscriber that the wireless device 302 has entered the buffer zone 308 or that the home network 304 may be available. In some implementations, the message can present to the subscriber at least one of a plurality of options including, for example, an option to end the active call and perform a network search procedure, an option to delay the network search procedure until after the active call ends, or an option to take no action. These message examples are not limiting, and other types of messages may also be presented to the subscriber.

In some implementations, the software component 302a can be configured to retrieve from an internal system of the wireless device 302 an active data session indicator that indicates that the wireless device 302 is in an active data session. In some implementations, when the active data session indicator indicates that the wireless device 302 is in an active data transfer, the software component 302a can be configured to delay taking the at least one of a plurality of actions until after the wireless device 302 is no longer in the active data session. In some implementations, when the active data session indicator indicates that the wireless device 302 is in an active data session, the software component 302a can be configured to cause a message to be displayed on the screen of the wireless device 302. In some implementations, the message can indicate to the subscriber that the wireless device 302 has entered the buffer zone 308 or that the home network 304 may be available. In some implementations, the message can present to the subscriber at least one of a plurality of options including, for example, an option to end the active data session and perform a network search procedure, an option to delay the network search procedure until after the active data session, or an option to take no action. These message examples are not limiting, and other types of messages may also be presented to the subscriber. In some implementations, the software component 302a can be configured to initiate a network search procedure in the background without notifying the subscriber.

In some implementations, the wireless device 302 or the software component 302a can be configured to determine whether the wireless device 302 is roaming internationally, i.e., outside the home country of the subscriber or the home network 304. In some implementations, for example, the software component 302a can determine that the wireless device is roaming outside its home country by comparing the MCC identifier component of the PLMN identifier of the network to which the wireless device 302 is connected to the MCC identifier component of the PLMN identifier of the home network 304. If the MCC identifiers match, the wireless device 302 or the software component 302a can determine that the wireless device 302 is not roaming internationally. If the MCC identifiers do not match, the wireless device 302 or the software component 302a can determine that the wireless device 302 is roaming internationally outside the home country of the subscriber or the home network 304. The particular method used by the wireless device 302 or the software component 302a to determine whether the wireless device 302 is roaming internationally should not be construed as limiting, and the software component 302a may retrieve an indication about the wireless device 302's international roaming status using any of the methods generally used in the art to determine whether the wireless device 302 has entered an international roaming mode of operation. In some implementations, when the software component 302a determines that the wireless device 302 is roaming internationally, the software component 302a can be configured to avoid expending energy to search for a signal of the home network 304, which may not exist in a foreign country, by not initiating a network search procedure.

The steering of the wireless device 302 to its home network 304 is opportunistic in the sense that the system identifies an opportunity to bring the wireless device 302 back to its home network 304 and initiates an action to do so without waiting for the standard 3GPP-defined network search procedures that may be implemented in the visited network 310.

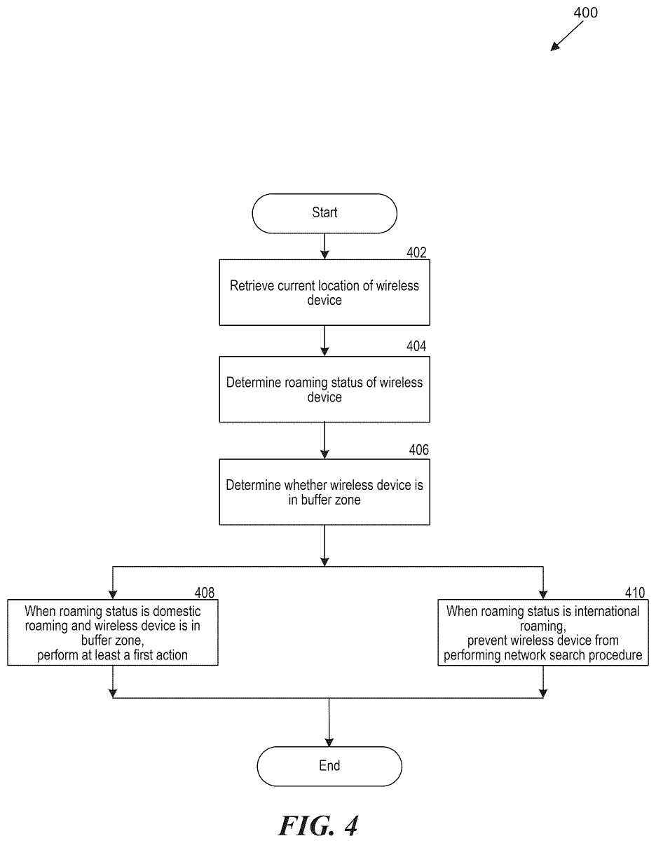

FIG. 4 is a flowchart illustrating a method 400 for implementing at least some aspects of the disclosed technology. In some embodiments, the disclosed technology can be implemented as a software component in a wireless device. In some embodiments, the disclosed technology can be implemented as a remote software component implemented in a system of a telecommunications network. The remote software component can be referred to herein as a roaming management function (RMF), and the RMF can be configured as a network element disposed in the telecommunications network. When the disclosed technology is implemented at the RMF, the RMF can receive, from the wireless device, a current location of the wireless device and a roaming status of the wireless device.

At 402, the wireless device retrieves a current location of the wireless device. At 404, the wireless device determines a roaming status of the wireless device based on a comparison of a public land mobile network (PLMN) identifier of a network to which the wireless device is currently connected and a PLMN identifier of a home network of the wireless device. The PLMN identifier of the network to which the wireless device is currently connected and the PLMN identifier of the home network of the wireless device can each comprise a mobile country code (MCC) identifier and a mobile network code (MNC) identifier. The roaming status of the wireless device can be not roaming when the PLMN identifier of the network to which the wireless device is currently connected matches the PLMN identifier of the home network of the wireless device. The roaming status of the wireless device can be domestic roaming when the MCC identifier of the network to which the wireless device is currently connected matches a country code of a country in which the home network of the wireless device is located. The roaming status of the wireless device can be international roaming when the MCC identifier of the network to which the wireless device is currently connected does not match the country code of the country in which the home network of the wireless device is located.

At 406, a determination is made regarding whether the current location of the wireless device is within a buffer zone. In some embodiments, when the disclosed technology is implemented in the wireless device, the determination can be made by the wireless device. In some embodiments, when the disclosed technology is implemented in the RMF, the determination can be made by the RMF. In some embodiments, the buffer zone can be known to the wireless device. The buffer zone is a geographical area that is a difference between a first polygon defining a coverage footprint of a plurality of network nodes of the home network and a second polygon extending a first threshold distance outward from the coverage footprint of the plurality of network nodes of the home network. In some embodiments, the plurality of network nodes of the home network can include all network nodes in the home network. In some embodiments, the plurality of network nodes of the home network can include a subset of network nodes of the home network that are within a second threshold distance from the current location of the wireless device. In some embodiments, the buffer zone can be known to the wireless device from a message received by the wireless device when the wireless device moves out of the coverage footprint of a first subset of network nodes of the home network and into the coverage footprint of a second subset of network nodes. In some embodiments, the buffer zone can be known to the wireless device from a message received by the wireless device from the home network when the wireless device is powered on. In some embodiments, the buffer zone can be known to the wireless device from a message received by the wireless device from the home network in response to a request sent by the wireless device to the home network.

At 408, in response to the determination that the roaming status of the wireless device is domestic roaming, and the current location of the wireless device is within the buffer zone, at least one action related to a network search procedure of the wireless device can be performed. In some embodiments, when the disclosed technology is implemented in the wireless device, the at least one action can be performed by the wireless device. In some embodiments, when the disclosed technology is implemented in the RMF, the at least one action can be performed by the RMF. When the at least one action is performed by the RMF, the at least one action can include sending an instruction to the wireless device. In some implementations, the at least one action can include initiating a network search procedure on the wireless device. In some implementations, the at least one action can include entering a Radio Resource Control (RRC) Idle (RRC_Idle) connection state of the wireless device. In some implementations, the at least one action can include sequentially entering and exiting an airplane mode of operation of the device. Entering the airplane mode of operation of the wireless device can further include disabling a cellular radio of the wireless device, and exiting the airplane mode of operation of the wireless device can further include enabling the cellular radio of the wireless device.

In some implementations, when the disclosed technology is implemented in the wireless device, the at least one action can include monitoring a call status of the wireless device to determine whether the call status of the wireless device is in-call or not-in-call. The call status of the wireless device can be in-call when the wireless device is in an active voice call. The call status of the wireless device can be not-in-call when the wireless device is not in an active voice call. In some embodiments, upon determining that the call status of the wireless device is in-call, the wireless device can delay performance of at least a second action related to a network search procedure of the wireless device until after the wireless device changes to not-in-call. In some embodiments, the at least a second action can include initiating a network search procedure on the wireless device. In some embodiments, the at least a second action can include entering an RRC Idle (RRC_Idle) connection state of the wireless device. In some embodiments, the at least a second action can include sequentially entering and exiting an airplane mode of operation of the device. Entering the airplane mode of operation of the wireless device can further include disabling a cellular radio of the wireless device, and exiting the airplane mode of operation of the wireless device can further include enabling the cellular radio of the wireless device. In some embodiments, upon determining that the call status of the wireless device is in-call, the wireless device can present a notification on a display screen of the wireless device. In some embodiments, the notification can include an option for a subscriber of the wireless device to initiate a network search procedure. At 410, in response to determining that the roaming status of the wireless device is international roaming, the wireless device can be prevented from performing a network search procedure.

### Computer System

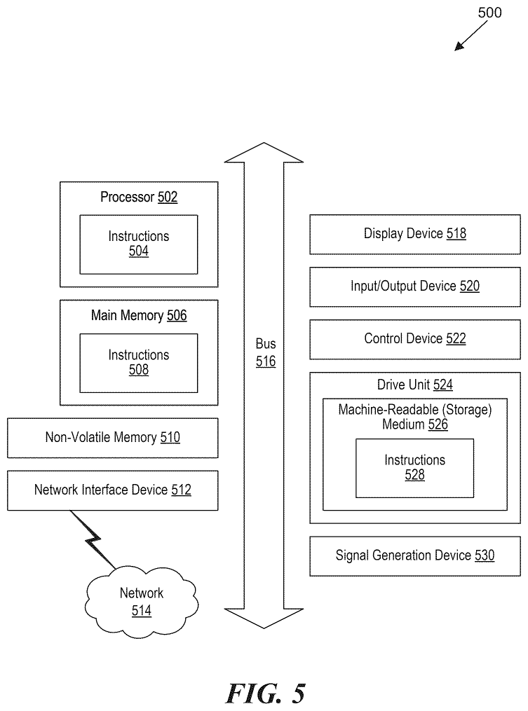

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A wireless device comprising:
at least one hardware processor; and
at least one non-transitory memory storing instructions, which, when executed by the at least one hardware processor, cause the wireless device to:
retrieve a current location of the wireless device;
determine a roaming status of the wireless device based on a comparison of a public land mobile network (PLMN) identifier of a network to which the wireless device is currently connected and a PLMN identifier of a home network of the wireless device,
wherein the PLMN identifier of the network to which the wireless device is currently connected and the PLMN identifier of the home network of the wireless device each comprise a mobile country code (MCC) identifier and a mobile network code (MNC) identifier,
wherein the roaming status of the wireless device is not roaming when the PLMN identifier of the network to which the wireless device is currently connected matches the PLMN identifier of the home network of the wireless device,
wherein the roaming status of the wireless device is domestic roaming when the MCC identifier of the network to which the wireless device is currently connected matches a country code of a country in which the home network of the wireless device is located, and
wherein the roaming status of the wireless device is international roaming when the MCC identifier of the network to which the wireless device is currently connected does not match the country code of the country in which the home network of the wireless device is located;
determine whether the current location of the wireless device is within a buffer zone that is known to the wireless device,
wherein the buffer zone is a geographical area that is a difference between a first polygon defining a coverage footprint of a plurality of network nodes of the home network and a second polygon extending a first threshold distance outward from the coverage footprint of the plurality of network nodes of the home network; and
in response to determining that the roaming status of the wireless device is domestic roaming and the current location of the wireless device is within the buffer zone, perform at least one action related to a network search procedure of the wireless device.

2. The wireless device of claim 1 caused to:
in response to determining that the roaming status of the wireless device is domestic roaming and the current location of the wireless device is within the buffer zone, perform at least one action related to a network search procedure of the wireless device,
wherein the at least one action includes initiating a network search procedure on the wireless device.

3. The wireless device of claim 1 caused to:
in response to determining that the roaming status of the wireless device is domestic roaming and the current location of the wireless device is within the buffer zone, perform at least one action related to a network search procedure of the wireless device,
wherein the at least one action includes entering a Radio Resource Control (RRC) Idle (RRC_Idle) connection state of the wireless device.

4. The wireless device of claim 1 caused to:
in response to determining that the roaming status of the wireless device is domestic roaming and the current location of the wireless device is within the buffer zone, perform at least one action related to a network search procedure of the wireless device,
wherein the at least one action includes sequentially entering and exiting an airplane mode of operation of the wireless device,
wherein entering the airplane mode of operation of the wireless device includes disabling a cellular radio of the wireless device, and
wherein exiting the airplane mode of operation of the wireless device includes enabling the cellular radio of the wireless device.

5. The wireless device of claim 1 caused to:
in response to determining that the roaming status of the wireless device is domestic roaming and the current location of the wireless device is within the buffer zone, perform at least one action related to a network search procedure of the wireless device,
wherein the at least one action includes:
monitoring a call status of the wireless device to determine whether the call status of the wireless device is in-call or not-in-call,
wherein the call status of the wireless device is in-call when the wireless device is in an active voice call, and
wherein the call status of the wireless device is not-in-call when the wireless device is not in an active voice call; and
upon determining that the call status of the wireless device is in-call, delaying performance of at least a second action related to a network search procedure of the wireless device until after the wireless device changes to not-in-call.

6. The wireless device of claim 5,
wherein the at least a second action is initiating a network search procedure on the wireless device.

7. The wireless device of claim 5,
wherein the at least a second action is entering a Radio Resource Control (RRC) Idle (RRC_Idle) connection state of the wireless device.

8. The wireless device of claim 5,
wherein the at least a second action is sequentially entering and exiting an airplane mode of operation of the wireless device,
wherein entering the airplane mode of operation of the wireless device includes disabling a cellular radio of the wireless device, and
wherein exiting the airplane mode of operation of the wireless device includes enabling the cellular radio of the wireless device.

9. The wireless device of claim 1 caused to:
in response to determining that the roaming status of the wireless device is domestic roaming and the current location of the wireless device is within the buffer zone, perform at least one action related to a network search procedure of the wireless device,
wherein the at least one action includes causing the wireless device to:
monitor a call status of the wireless device to determine whether the call status of the wireless device is in-call or not-in-call,
wherein the call status of the wireless device is in-call when the wireless device is in an active voice call, and
wherein the call status of the wireless device is not-in-call when the wireless device is not in an active voice call; and
upon determining that the call status of the wireless device is in-call, present a notification on a display screen of the wireless device.

10. The wireless device of claim 9,
wherein the notification includes an option for a subscriber of the wireless device to initiate a network search procedure.

11. The wireless device of claim 1 caused to:
in response to determining that the roaming status of the wireless device is international roaming, prevent the wireless device from performing a network search procedure.

12. The wireless device of claim 1,
wherein the plurality of network nodes of the home network includes all network nodes in the home network.

13. The wireless device of claim 1,
wherein the plurality of network nodes of the home network includes a subset of network nodes of the home network that are within a second threshold distance from the current location of the wireless device.

14. The wireless device of claim 13,
wherein the buffer zone is known to the wireless device from a message received by the wireless device when the wireless device moves out of a coverage footprint of a first subset of network nodes of the home network and into a coverage footprint of a second subset of network nodes.

15. The wireless device of claim 1,
wherein the buffer zone is known to the wireless device from a message received by the wireless device from the home network when the wireless device is powered on.

16. The wireless device of claim 1,
wherein the buffer zone is known to the wireless device from a message received by the wireless device from the home network in response to a request sent by the wireless device to the home network.

17. A system of a telecommunications network comprising a roaming management function (RMF) configured as a network element disposed in the telecommunications network, the RMF including:
at least one hardware processor; and
at least one non-transitory memory storing instructions, which, when executed by the at least one hardware processor, cause the RMF to:
receive, from a wireless device, a current location of the wireless device and a roaming status of the wireless device,
wherein the wireless device is configured to determine the roaming status of the wireless device based on a comparison of a public land mobile network (PLMN) identifier of a network to which the wireless device is currently connected and a PLMN identifier of the telecommunications network,
wherein the PLMN identifier of the network to which the wireless device is currently connected and the PLMN identifier of the telecommunications network each comprise a mobile country code (MCC) identifier and a mobile network code (MNC) identifier,
wherein the roaming status of the wireless device is not roaming when the PLMN identifier of the network to which the wireless device is currently connected matches the PLMN identifier of the telecommunications network,
wherein the roaming status of the wireless device is domestic roaming when the MCC identifier of the network to which the wireless device is currently connected matches a country code of a country in which the telecommunications network is located, and
wherein the roaming status of the wireless device is international roaming when the MCC identifier of the network to which the wireless device is currently connected does not match the country code of the country in which the telecommunications network is located;
determine whether the current location of the wireless device is within a buffer zone,
wherein the buffer zone is a geographical area that is a difference between a first polygon defining a coverage footprint of a plurality of network nodes of the telecommunications network and a second polygon extending a first threshold distance outward from the coverage footprint of the plurality of network nodes of the telecommunications network; and
in response to determining that the roaming status of the wireless device is domestic roaming and the current location of the wireless device is within the buffer zone, perform at least one action related to a network search procedure of the wireless device.

18. The system of claim 17 wherein the RMF is caused to:
in response to determining that the roaming status of the wireless device is domestic roaming and the current location of the wireless device is within the buffer zone, perform at least one action related to a network search procedure of the wireless device,
wherein the at least one action related to the network search procedure of the wireless device includes sending an instruction to the wireless device to initiate a network search procedure on the wireless device, enter a Radio Resource Control (RRC) Idle (RRC_Idle) connection state of the wireless device, or sequentially enter and exit an airplane mode of operation of the wireless device,
wherein entering the airplane mode of operation of the wireless device includes disabling a cellular radio of the wireless device, and
wherein exiting the airplane mode of operation of the wireless device includes enabling the cellular radio of the wireless device.

19. The system of claim 17 wherein the RMF is caused to:
in response to receiving the roaming status of the wireless device as international roaming, send an instruction to the wireless device to prevent the wireless device from performing a network search procedure.

20. A method for managing a network search procedure of a wireless device, the method comprising:
retrieving, by the wireless device, a current location of the wireless device;
determining, by the wireless device, a roaming status of the wireless device based on a comparison of a public land mobile network (PLMN) identifier of a network to which the wireless device is currently connected and a PLMN identifier of a home network of the wireless device,
wherein the PLMN identifier of the network to which the wireless device is currently connected and the PLMN identifier of the home network of the wireless device each comprise a mobile country code (MCC) identifier and a mobile network code (MNC) identifier,
wherein the roaming status of the wireless device is not roaming when the PLMN identifier of the network to which the wireless device is currently connected matches the PLMN identifier of the home network of the wireless device,
wherein the roaming status of the wireless device is domestic roaming when the MCC identifier of the network to which the wireless device is currently connected matches a country code of a country in which the home network of the wireless device is located, and
wherein the roaming status of the wireless device is international roaming when the MCC identifier of the network to which the wireless device is currently connected does not match the country code of the country in which the home network of the wireless device is located;
determining, by the wireless device, whether the current location of the wireless device is within a buffer zone,
wherein the buffer zone is a geographical area that is a difference between a first polygon defining a coverage footprint of a plurality of network nodes of the home network and a second polygon extending a first threshold distance outward from the coverage footprint of the plurality of network nodes of the home network; and
in response to determining that the roaming status of the wireless device is domestic roaming, and the current location of the wireless device is within the buffer zone, performing, by the wireless device, at least one action related to a network search procedure of the wireless device,
wherein the at least one action related to the network search procedure of the wireless device includes initiating a network search procedure on the wireless device, entering a Radio Resource Control (RRC) Idle (RRC_Idle) connection state of the wireless device, or sequentially entering and exiting an airplane mode of operation of the wireless device,
wherein entering the airplane mode of operation of the wireless device includes disabling a cellular radio of the wireless device, and
wherein exiting the airplane mode of operation of the wireless device includes enabling the cellular radio of the wireless device.
